(19) United States
(12) Patent Application Publication
(10) Pub. No.: US 2015/0189234 A1
(43) Pub. Date: Jul. 2, 2015

(54) REAL TIME STREAM PROVISIONING INFRASTRUCTURE

(71) Applicant: OnCam, Inc., Phoenix, AZ (US)

(72) Inventor: Joe Shapiro, Paradise Valley, AZ (US)

(73) Assignee: OnCam, Inc., Phoenix, AZ (US)

(21) Appl. No.: 14/140,839

(22) Filed: Dec. 26, 2013

(51) Int. Cl. H04N 7/15

(52) U.S. Cl. CPC H04N 7/15

(57) ABSTRACT

There is disclosed a system and a method of real time stream provisioning. The method includes dynamically allocating one of a plurality of servers in a server cluster for use in a chat, the chat including an audio component for each of n chat participants and encoding the audio component for each of the n chat participants, using at least one graphical processing unit, into n audio streams, where the n audio streams each include audio components for n−1 of the n chat participants where each of the n audio streams does not include the audio component for a different one of the n chat participants. The method further comprises transmitting one of the n audio streams to the n chat participants such that a chat participant of each of the n chat participants receives an audio stream excluding the audio component associated with the chat participant.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent is related to U.S. patent application Ser. No. _____ filed _____ and entitled “CHAT PREAUTHORIZATION” and the U.S. patent application Ser. No. _____ filed _____ and entitled “PRIVATE-PUBLIC CHAT FUNCTIONALITY.”

### BACKGROUND

1. Field

This disclosure relates to a real time stream provisioning infrastructure for use in audio-visual multi-user chat interactions.

2. Description of the Related Art

Audio-visual chat has been available among a plurality of computer users for some time. For example, Skype® enables audio-visual user-to-user calling via a peer-to-peer system with server-based initiation and messaging protocols. More recently, Skype®, Facetime®, and Google® Hangouts have enabled various permutations of so-called “group” audio-visual chat sessions. Facetime® and Skype® also enable mobile-to-mobile single-user-to-single-user audio-visual calling.

In a related field, websites such as YouTube®, Netflix® and Vimeo® have enabled streaming of stored videos. Sites such as UStream® and Twit.tv® have enabled real time or “live” (or nearly-live) audio-visual streaming. Stored video streaming has relied upon conversion of the video into a format suitable for low-bandwidth streaming. In some cases, such as with Netflix®, algorithms can dynamically alter the quality of the stream in real-time so as to accommodate higher or lower bandwidth availability. Real time audio-visual streaming typically relies upon a single stream and, encodes the stream before it is broadcast directly from the stream to any number of watchers using multicast protocols. Some of these real time streaming services can operate directly from mobile devices, but offer limited streaming capabilities, low resolution, and delay the stream in order to account for issues related to mobile device processing capability, latency and bandwidth considerations.

### DESCRIPTION OF THE DRAWINGS

FIG. 1 is a block diagram of a real time stream provisioning infrastructure.

FIG. 2 is a block diagram of a computing device.

FIG. 3 is a block diagram of an encoding computing device.

FIG. 4 is a functional diagram of a real time stream provisioning infrastructure

FIG. 5 is a functional diagram of a server for video encoding.

FIG. 6 is a functional diagram of a server for audio encoding.

FIG. 7 is a flowchart of a video encoding process.

FIG. 8 is a flowchart of an audio encoding process.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Mobile devices have been virtually unable to take part in multi-party real-time audio-visual chat functionality. Most real-time audio-visual chat systems operate on a peer-to-peer basis, with the server's only function being to arrange the peer-to-peer connection. These systems rely upon one or more of the chat participant's computers to encode their own or each of the chat participant's audio and video before rebroadcasting to the group. In the case of an individual-to-individual chat involving a single mobile device and a more traditional computer, each device may encode its own audio and video and provide it to the other party's computing device.

However, in multi-party chats, particularly those involving a mixture of mobile devices and more traditional personal computers, the most efficient way to render all of the video and audio together is to combine it, using a single chat participant's computer into a single video stream and audio stream. The resulting streams are then broadcast to the group. This process fits well into the peer-to-peer model employed by these audio-visual chat services.

However, because there are multiple audio and visual components, one of each from each chat participant, modern mobile devices are unable to perform this multi-component encoding and network latency and bandwidth makes mobile devices unreliable for transmission of the resulting stream (or receipt of the components). Because of these limitations of mobile devices, these processes automatically select a more traditional computing device to perform these encoding processes. As a result, a multi-party real-time audio-visual chat involving only or primarily mobile devices, as of yet, has not been available.

Description of Apparatus

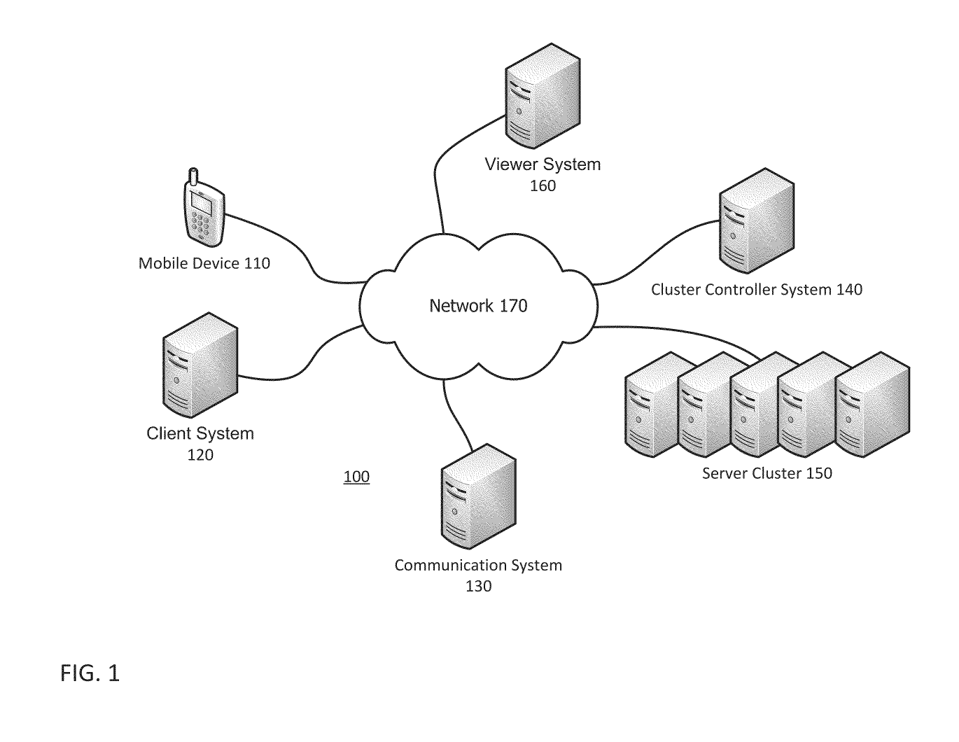

Referring now to FIG. 1, there is shown a block diagram of an environment for search and ranking of procedures to complete a task. The environment 100 includes a mobile device 110, a client system 120, a communication system 130, a cluster controller system 140, a server cluster 150, and a viewer system 160. Each of these elements are interconnected via a network 170.

The mobile device 110 and client system 120 are computing devices (see FIG. 1) that are used by chat participants and viewers in order to take part in or to view a chat. The mobile device 110 may be a mobile phone including a screen, a microphone and a video camera. The client system 120 may be a personal desktop computer, a tablet, a laptop or a similar device including a screen, a microphone and a video camera. The screen, microphone and video camera may be independent of or integral to either the mobile device 110 or the client system 120.

For purposes of this patent, the term “chat” means an audio and/or video simultaneous communication involving at least two chat participants. A “chat participant” is an individual taking part in a chat, using a mobile device 110 or a client system 120, and providing an audio and/or video component making up a part of the chat. A “chat viewer,” in contrast, is an individual viewing a chat, but not providing any audio and/or video component making up a part of the chat. In some situations, a “chat viewer” may, permanently or temporarily, be converted into a chat participant, either of their own volition, if allowed by the system, by an administrator of a chat, or by another chat participant.

An “audio component,” a “video component” or an “audio-visual component” as used herein means an audio and/or video stream provided by a single chat participant. A “combined” audio and video stream or audio-visual stream is an audio and/or video stream simultaneously incorporating the components of more than one chat participant in a single stream. A “master” audio stream, video stream, or audio-visual stream is an audio and/or video stream simultaneously incorporating the components of all chat participants.

The communication system 130 is a computing device that is responsible for routing communications, such as chat initiation requests, any text-based communication between chat participants and viewers, any unique chat identifiers, and the protocol communications necessary to establish, initiate, maintain, and end chat sessions. The communication system 130 may enable peer-to-peer sessions to be initiated. The communication system 130 may be made up of more than one physical or logical computing device in one or more locations.

The cluster controller system 140 is a computing device that is responsible for receiving chat initiation (and termination) requests and then identifying and allocating a server, from the server cluster 150, to handle audio-visual chats. The cluster controller system 140 may also maintain a full database of all ongoing chats and each participant in the ongoing chats. The cluster controller system 140 may operate as an organizer of the overall audio-visual chat process. In situations in which a server, from the server cluster 150, ceases to function or is no longer reachable on the network, the cluster controller system 140 may transition an in-process audio-visual chat to a newly-provisioned server within the server cluster 150.

The server cluster 150 is a group of servers that are available to be used to host one or more audio-visual chats. A server within the server cluster 150 is used to receive a plurality of audio and/or video components from a plurality of chat participants and to encode those into one or more combined audio and/or video streams. The server cluster 150 may, for example, be a set of dynamically available servers that may be allocated on an as-needed basis for use in one or more audio-visual chats. Amazon® and Microsoft® currently offer such servers that may be paid-for on an as-needed basis. As discussed more fully below, the servers making up the server cluster 150 each incorporate at least one graphical processing unit (GPU) for use in encoding audio and/or video.

The viewer system 160 is a computing device that is used to view an on-going audio-visual chat. The viewer system 160 is essentially the same as the mobile device 110 and the client system 120, but is used by a chat viewer. As a result, the viewer system 160 does not provide an audio and/or video component for inclusion in the chat. Instead, the viewer system 160 merely receives an audio and/or video stream.

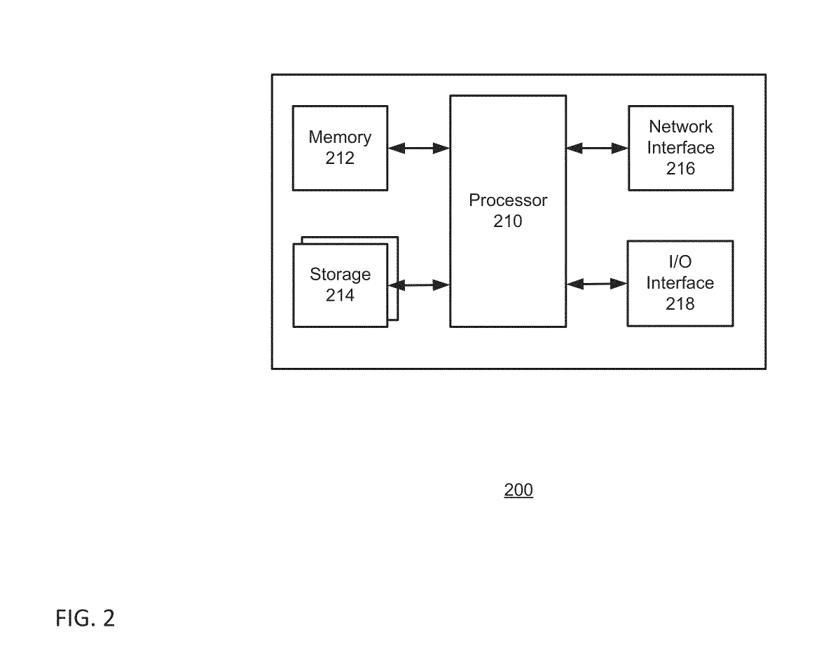

Turning now to FIG. 2 there is shown a block diagram of a computing device 200, which is representative of the mobile device 110, the client system 120, the communication system 130, the cluster controller system 140, and the viewer system 160 in FIG. 1. The computing device 200 may be, for example, a desktop or laptop computer, a server computer, a tablet, a smartphone or other mobile device. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor 210 may be or include one or more microprocessors, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 214 and does not include transitory media such as signals or waveforms. In some cases, such as those involving solid state memory devices, the memory 212 and storage 214 may be a single device.

The network interface 216 includes an interface to a network such as network 170 (FIG. 1). The network interface 216 may be wired or wireless.

The I/O interface 218 interfaces the processor 210 to peripherals (not shown) such as displays, video cameras, microphones, keyboards and USB devices.

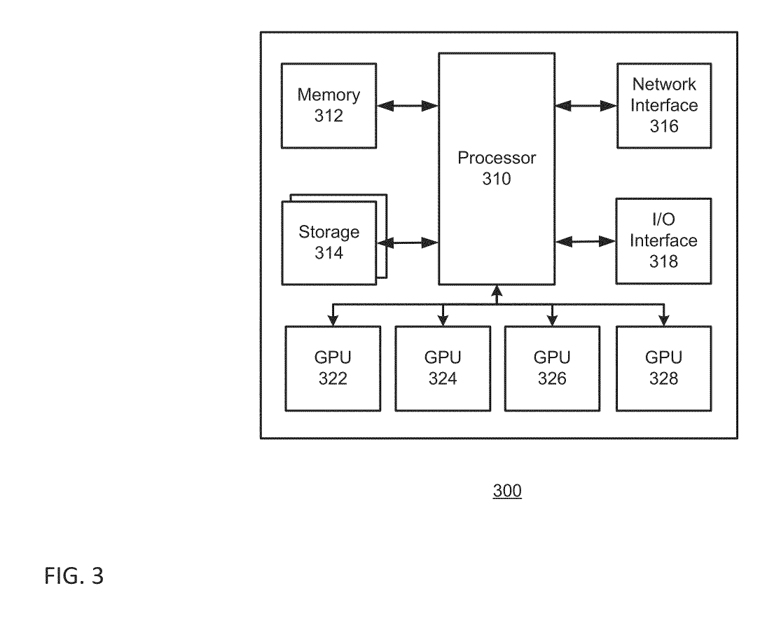

Turning now to FIG. 3 there is shown a block diagram of an encoding computing device 300, which is representative of the servers making up the server cluster 150 in FIG. 1. The processor 310, memory 312, storage 314, network interface 316 and I/O interface 318 of FIG. 3 serve the same function as the corresponding elements discussed with reference to FIG. 2 above. These will not be discussed further here.

The GPUs (graphical processing units) 322, 324, 326, and 328 are also present in this computing device 300. There may be more or fewer GPUs dependent upon the needs of the computing device 300. GPUs, such as GPU 322, are specialized processors including instruction sets designed specifically for processing visual-related algorithms. GPUs differ from CPUs (such as processor 310) primarily in that they are capable of interacting with memory directly allocated to the GPU very rapidly and, as a result, can manipulate the large quantities of data pertaining to computer visual functions stored in that memory very rapidly. In addition, GPUs typically incorporate a “frame buffer” which stores processed data in a format suitable for near-direct output to a computer display. Finally, GPUs, unlike most CPUs, offer high parallelism that enables them to process large blocks of data simultaneously.

In addition, multiple GPUs may be incorporated into a single computing device 300 to enable simultaneous processing by multiple GPUs. The computing device 300 may include, for example, five GPUs, each operating independently from one another and communicating with a single CPU (such as processor 310). As used herein a GPU is distinct from and in addition to a CPU. A GPU, as used herein, incorporates at least one specific instruction set for operating upon computer graphical data. The instruction set specific to the GPU and is not incorporated in the CPU.

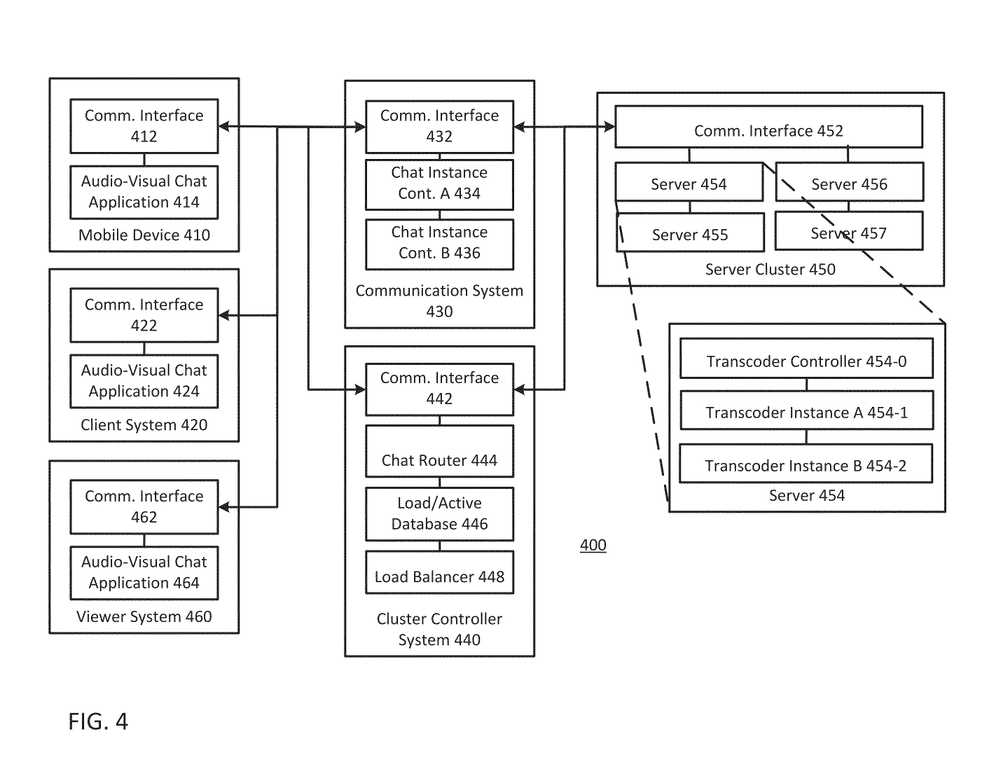

Turning now to FIG. 4, a functional diagram of a real time stream provisioning infrastructure 400 is shown. FIG. 4 corresponds to FIG. 1, but includes more detail regarding the functional elements making up the individual computing devices. As such, the mobile device 410, the client system 420, the communication system 430, the cluster controller system 440, the server cluster 450 and the viewer system 460 each have counterparts in FIG. 1.

The mobile device 410 and client system 420, each include a communication interface 412, 422 and an audio-visual chat application 414, 424. The communication interface 412, 422 are used to enable textual chat between chat participants. The textual chat may take the form of an asynchronous communication between the chat participants and may include text, images (such as .jpg, .gif) and embedded videos (such as from YouTube® and similar video sharing sites).

The communication interface 412, 422 is also used to transfer signaling and protocol related messages pertaining to the creation, maintenance and ending of chats between the mobile device 410, the client system 420, any viewer systems 460 and the cluster controller system 440 and the server cluster 450. These messages signal to the communication system 430 which then signals messages to cluster controller system 440, the server cluster 450 and to the mobile devices and client systems associated with chat participants that at least one chat participant wishes to initiate, continue, and/or end a chat. In addition, messages identifying the chat participants and any viewers and, potentially, identifying the types of computing devices used for those chats, the connection, the status of whether those chat participants or viewers remain and numerous other types of information that may be relevant to the cluster controller system 440, the server cluster 450, using the communication system 430, and communication interface 412, 422.

The audio-visual chat application 414, 424 operate to receive audio and/or video components provided by a chat participant using either a mobile device 410 or a client system 420 and to cause those components to be transmitted to (or through) a cluster controller system 440 for combination into one or more combined streams. The audio-visual chat application 414, 424 may then receive the one or more combined streams and display those to a chat participant using the mobile device 410 or the client system 420.

The communication system 430 uses a communication interface 432 to communicate chat requests, initiation messages, chat end messages, and related protocol messages to and from chat participants and any of the infrastructure 400 elements. The communication system 430 may provide, for example, a uniform resource locator (URL) for a particular chat session or a particular chat participant. This URL may redirect requests to an associated real-time audio and/or video stream.

The communication system 430 also includes chat instance controllers, such as chat instance controller A 434 and chat instance controller B 436, for each concurrent chat operating on the system. These controllers 434 and 436 operate as central hubs for all protocol, text, audio components and video components making up a part of a particular chat. A chat may be identified by a particular chat ID, with protocol messages, text, audio components and video components directed to the communication system using the chat ID to determine which chat instance controller the data is directed.

One example of a communication system like the communication system 430 is a system currently provided by Wowza® which enables publication of audio and video components by individual users and further enables publication of a resulting combined or master stream to a plurality of chat participants and chat viewers. Wowza®, among other things, incorporates a protocol for initiating the broadcast (or transmission) of those streams and for receipt of the combined stream for broadcasting to an identified group of chat participants and chat viewers. These protocols are an example of the communication protocols used by the communication interface 412, 422, although many other systems offering similar functionality may be used. Additional or different systems may make up all or a part of the communication system 430 which may also enable text chat, routing of protocol messages, sharing of audio/visual data via social networks, social network API integration, instant messaging and other, similar functions.

The cluster controller system 440 is primarily responsible for acting as an orchestrator and a conduit for audio component and video component encoding operations that are passed to the server cluster 450. The cluster controller system 440 incorporates a communication interface 432, a chat router 444, a load/active database 446 and a load balancer 448. The communication interface 442 operates, in conjunction with the communication system 430, to receive and route chat requests, maintenance messages and chat termination messages.

The chat router 444 operates to direct incoming audio and/or video components from one or more chat participants to a server within the server cluster (or to a newly-allocated server) for encoding of the audio and/or video components into one or more combined streams. The load/active database 446 maintains a database of all on-going chats and all participants and viewers for each of those chats. This enables the cluster controller system 440 to determine which audio and/or video components and which combined and master streams pertain to which chats and/or chat participants and chat viewers.

In addition, the load/active database 446 maintains a database of the overall load associated with the encoding operations of each server making up the server cluster 450. This enables the cluster controller system 440 to determine which server, of the server cluster 450, would be best-suited to service a new chat and when to activate additional servers available to the server cluster 150 in order to avoid overextending one or more server's capacity to host chats.

Similarly, the load balancer 448 uses the information in the load/active database to activate new servers, deactivate unused (or underused) servers, to transfer ongoing chats in real-time to less-utilized servers and to otherwise ensure that an efficient use of the server cluster 450 is taking place. In the event of a server failure, the load balancer 448 may use the information in the load/active database 446 to quickly transition all ongoing chats to one or more other servers.

The server cluster 450 is a group of servers 454, 455, 456, 457 and an associated communication interface 452 that are responsible for encoding multiple audio and/or video components into one or more combined or master streams.

Each server in the server cluster 450, such as server 454, can include a transcoder controller 454-0 that is responsible for directing transcoding of audio and/or video components and other messages to one of a plurality of transcoder instances 454-1, 454-2 operating on that server 454. The transcoder controller 454-0 may also report back usages and load data to the load/active database 446 for use by the load balancer 448. Incoming audio and/or video components may only be identified by a chat ID, and the transcoder controller 454-0 may use that to direct the stream to the appropriate transcoder instance.

The transcoder instances A 454-1 and B 454-2 are responsible for directing one or more GPUs on the server 454 to transcode audio and/or video components into a series of combined audio and/or video streams for service back to one or more of the chat participants.

The viewer system 460 operates in virtually the same fashion as the mobile device 410 and the client system 420. However, the audio-visual chat application 464 of a chat viewer using the viewer system 460 does not provide an audio and/or video component for combination into a combined or master stream.

As indicated above, the chat viewer using the viewer system 460 may, temporarily or permanently, become a chat participant. In such a case, the communication interface 462 communicates a desire to become a chat participant in an ongoing chat or in a new chat, the communication system 430 provisions that chat in interaction with the cluster controller system 440 and adds the chat viewer (now participant) to a chat instance on a server available to the server cluster 450.

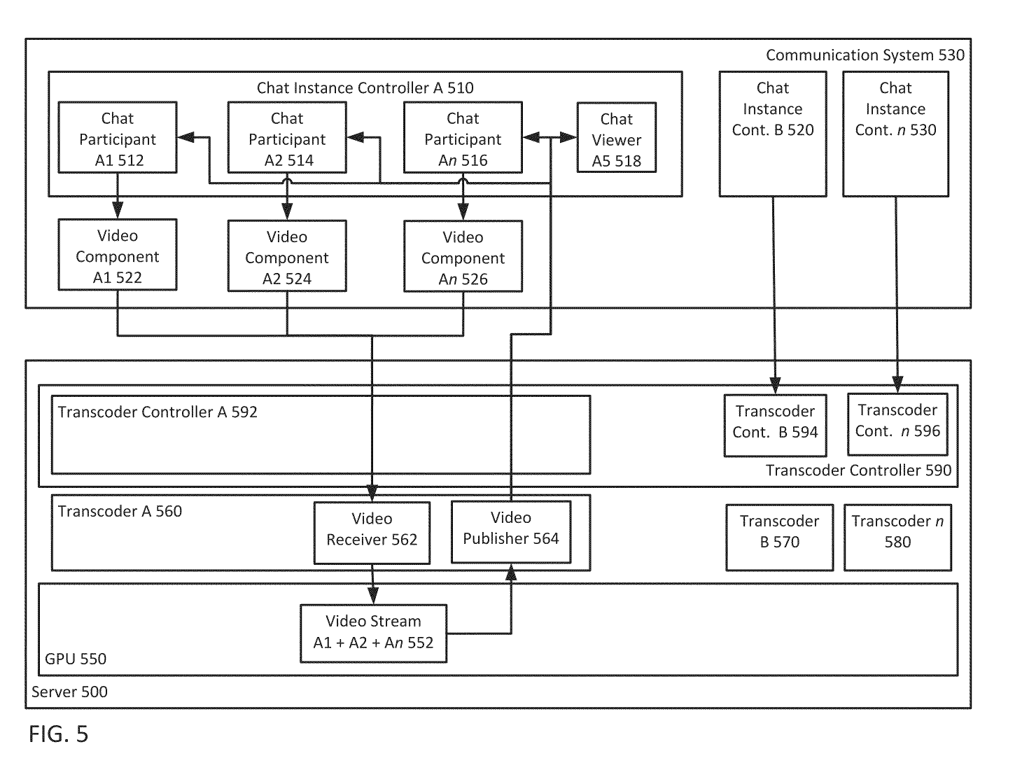

FIG. 5 is a functional diagram of server 500 and a communication system for video encoding 530. The server 500 is one of the servers in a server cluster, such as server cluster 450 in FIG. 4. The communication system 530 may be the communication system 430 of FIG. 4. All communication in the system may be routed through the communication system 530, may utilize one or more APIs operating on the server 500 or within the various elements allocated for a particular chat instance. For example, an API within a given transcoder controller may communicate, using the communication system 530, directly with a chat instance controller for that chat instance.

The communication system 530 includes a plurality of chat instance controllers A 510, B 520, and n 530. The chat instance controller A 510, as discussed above, ensures that video received by the system that is associated with a particular chat instance is routed and returned to the appropriate chat instance for chat participants and any chat viewers.

The server 500 includes a transcoder controller 590, transcoders A 592, B 594 and n 596, and a GPU 550. The transcoder controller 590 controls the operation of the transcoders A 592, B 594, and n 596. The transcoder controllers A 592, B 594 and n 596 are responsible for directing the conversion of audio and video components received from their respective chat instance controllers A 510, B 520, and n 530 into combined or master audio or video streams while under the direction of transcoder controller 590. The transcoding takes place on the GPU 550.

Each transcoder, such as transcoder A 560, includes a video receiver, such as video receiver 562, and a video publisher, such as video publisher 564. Each video receiver 562 receives each of the video components for the chat instance controller associated with the transcoder. For example, the video receiver 562 for transcoder A 560 receives the video components A1 522, A2 524, and An 526 associated with chat instance controller A 510.

The video components are then provided by the video receiver 562 to the GPU 550 to be combined into video stream A1+A2+An 552. Once the video components are combined into a master video stream, the master stream is provided to the video publisher 564 that ensures that the master video stream reaches all of the chat participants A1 512, A2 514, An 516 and any chat viewers, such as chat viewer A5 518 associated with chat instance controller A 510.

The chat instance controller A 510, and all other chat instance controllers on a given communication system 530, are made up of data objects that incorporate a unique chat ID which is associated with a set of chat participants and any chat viewers. In this case, chat participant A1 512, chat participant A2 514, and chat participant An 516 make up chat instance A, operating on chat instance controller A 510 allocated to that chat instance. Chat viewer 518 may be associated with chat instance A and, similarly, operate on chat instance controller 510 as a chat viewer (not a chat participant). This means that audio and/or video components generated by these chat participants and viewers that is meant for the chat ID associated with chat instance A will be appropriately routed by the chat instance controller A 510 to these chat participants and chat viewers. Similarly, any resulting combined or master streams will be routed back to the appropriate chat participants and chat viewers.

The chat instance controller 510 may receive (from the chat router 444, through the communication interface 432), as a part of an ongoing chat instance, such as chat instance A, video components from the chat participants. Examples of such video components are shown as video component A1 522, video component A2 524, and video component An 526.

These components are routed to a transcoder controller A 592 allocated on the server 500 for a chat instance A. In this case, video components associated with chat instance A are routed to transcoder controller A 592. Similarly, video components associated with chat instance B 520 are routed to transcoder controller B 594 and to transcoder B 570 associated with chat instance controller B 520. Video components associated with chat instance n 530 are routed to transcoder controller n 596 and to transcoder n 580. The transcoders, such as transcoder A 560, accept a plurality of video components, prepare those components for encoding, and package those components for encoding using GPU 550.

The GPU 550 within the server 500 is used for encoding into a single video stream including the video components of A1 522, A2 524 and An 526. This is encoded as video stream A1+A2+An 552. User and/or server settings may determine how this encoding takes place. For example, the videos may be overlaid, may be boxed into set portions of an overall stream (when displayed) or may otherwise be organized into a single master A1+A2+An 552 stream. In addition, timing data may be transmitted with the video components in order to enable the GPU to properly synchronize video data that is not necessarily received simultaneously from all of the chat participants. This same master stream may then be returned to all of the chat participants A1 512, A2 514, An 516 and to any chat viewers, such as chat viewer A5 518.

This master stream may be transmitted using user datagram protocol (UDP). UDP prioritizes throughput over ensured delivery. In this way, the master stream is continuously sent, regardless of whether a particular chat participant or chat viewer has received or acknowledged delivery. The most important priority is ensuring that the master stream continues to be sent, not ensuring that every participant (one or more may have intentionally or unintentionally dropped out of the chat) has received every frame of video or audio.

The resulting video stream utilizes substantially less bandwidth than directly providing each, individual video component to each of the chat participants and each chat viewer for combination therein. Similarly, this process utilizes less CPU cycles on any one of the chat participant computing devices than would be necessary for that computing device to encode all of the video into a single stream or for each participant or viewer computing device to simultaneously receive, decode, synchronize and then display each of these video components. This is particularly acute when there are many chat participants and each of the chat participant's resulting video streams or when many or all of the chat participants are on mobile devices.

The use of a server, such as server 500 at all is unusual in these types of systems. Typically, these systems rely upon the computing power of one or more of the chat participant's computing devices to encode some or all of the video for each of the chat participants in a given video chat session. Particularly in the context of an entirely-mobile video chat session, the chat participant computing devices are not necessarily capable of performing this function. The bandwidth considerations and latency issues related to mobile devices in addition to the more-limited computing power associated with such devices makes using those devices to perform these functions difficult or impractical.

As a result, a server, such as server 500, is used to perform these functions. However, again, utilizing a single server to perform the encoding of more than a few (3-5) simultaneous chats involving a few (3-5) chat participants results in that server being overloaded and, in some cases, ceasing to function or becoming otherwise unavailable. The raw data associated with multiple video streams alone is very bandwidth and memory intensive. A single server has difficulty keeping up with such huge volumes of data, both in network bandwidth and in CPU throughput. Adding additional servers is an option, but each additional server costs money to initialize, to maintain and to administer. The costs associated with providing an individual, dedicated server for each set of only a few simultaneous on-going audio-visual chat sessions makes continued allocation of additional servers prohibitive.

As a result, the present system may use servers which incorporate a plurality of GPUs operating simultaneously within each of the servers to provide additional processing power necessary to overcome the single-server limitations regarding a total number of simultaneous chat sessions. In particular, the GPU's direct access to high-speed memory and the GPUs capability to simultaneously operate on large chunks of data enable the GPUs to quickly synchronize and encode multiple, simultaneous video components into a plurality of combined and master video streams. The CPU, the primary processor for a server, may primarily operate the transcoder controller 590 for a given server 500 and direct the various video streams to their appropriate places where they may then be operated upon by the GPUs. In this way, a single server, having at least one GPU, of current, typical capability may handle anywhere from 5-100 simultaneous chats involving three or more individual chat participants and any number of chat viewers. Additional simultaneous chats may be possible under the same system using later server and GPU technology.

The GPU 550 encoding the video uses lock-free memory, meaning that no single chat participant or chat instance can make any part of the data in memory un-editable. This serves to enable the encoding process to continue operating even if one or more chat participants have high latency or are non-responsive. In addition, incoming new video components are not skipped in the encoding process. So, for example, if additional video data comes in for one chat participant while the remaining chat participants have yet to provide data, the video for the single chat participant is encoded along with the last video component received for the remaining chat participants so as to continue the master video stream advancing, even though only a single participant has provided new data. The GPU does not “lock” any data awaiting input from other chat participants.

In addition, the GPU 550 may utilize blocking of data such that large collections of data are operated upon simultaneously. These collections may be time-allocated, meaning that they are allocated in collections based upon when the video components arrive at the GPU 550. These collections may be type-allocated, meaning that similar video portions that are received within a reasonable time-frame of one another may be grouped for processing because the GPU 550 can perform similar operations at once on different collections of data.

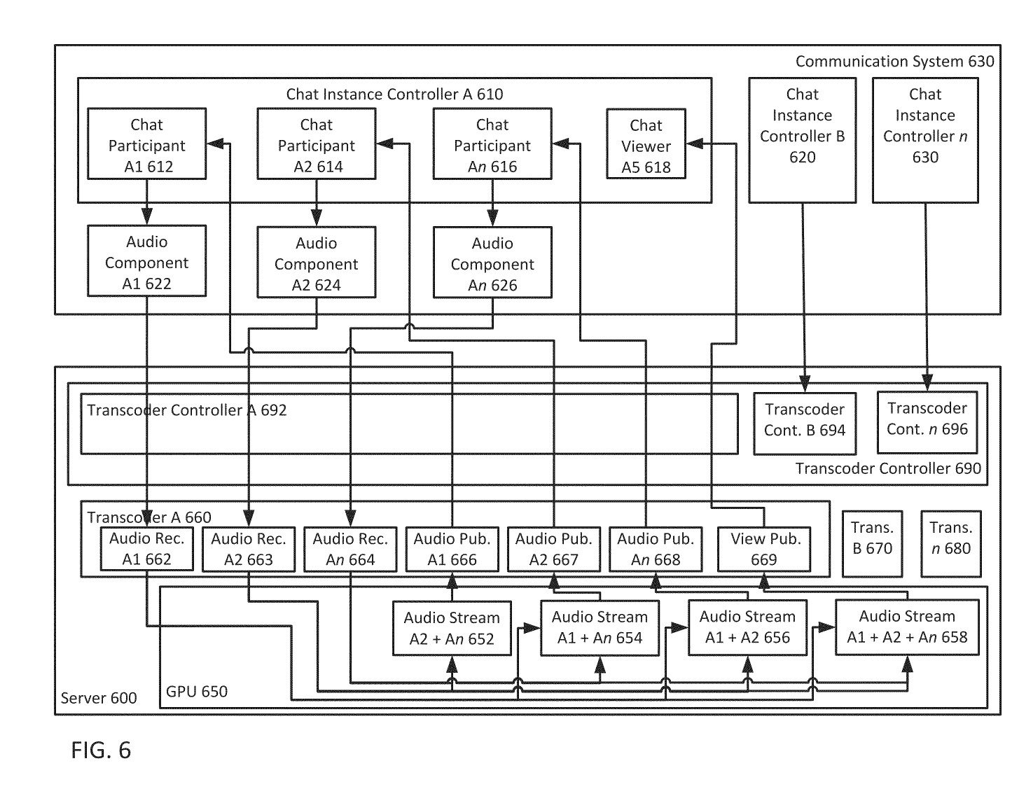

FIG. 6 is a functional diagram of a server 600 and a communication system 630 for audio encoding. The communication system 630 incorporates all of the elements of the communication system 530 in FIG. 5. The chat instance controller A 610, chat instance controller B 620, the chat instance controller n 630, the transcoder controller 690 and the GPU 650 may serve virtually identical functions to that described above with reference to FIG. 5, except those systems function in the same manner with regard to audio components and combined or master audio streams rather than video components and streams. Those descriptions will not be repeated here.

Unlike the video transcoding described above, each audio transcoder, such as transcoder A 660, includes an audio receiver for each chat participant in an associated chat instance controller, such as chat instance controller A 610. Similarly, an audio publisher for each chat participant, along with a single audio publisher used for each chat viewer is provided. For chat instance controller A 610, there are three chat participants, A1 612, A2 614, and An 616 along with a single chat viewer A5 618. Accordingly, there are three audio receivers A1 662, A2 663, and An 664, three audio publishers A1 666, A2 667, and An 668, and one viewer publisher 669.

The audio components A1 622, A2 624, and An 626 are each received in transcoder A 660 at their respective audio receivers A1 662, A2 663, and An 664. These are passed to the GPU 650 for encoding.

Once the GPU 650 receives audio components A1 622, A2 624, and An 626 from the transcoder A 660, the GPU 650 simultaneously encodes n combined audio streams where n is the total number of chat participants. Each of these individual combined audio streams incorporates all of the audio associated with every chat participant except for one. The GPU 650 then returns the n combined audio streams to the respective audio publisher in transcoder A 660 which routes the combined audio streams such that the missing audio component for a given chat participant is their own audio component.

The audio publisher A1 666 receives the audio stream A2+An 652, the audio publisher A2 667 receives the audio stream A1+An 654, and the audio publisher An 668 receives audio stream A1+A2 656. Finally, the viewer publisher 669 receives a master audio stream A1+A2+An 658. Audio publisher A1 666 passes the received audio stream A2+An 652 to chat participant A1 612. Audio publisher A2 667 passes the received audio stream A1+An 654 to chat participant A2 614. Audio publisher An 668 passes the received audio stream A1+A2 656 to chat participant An 616. Chat viewer A5 618 receives the master audio stream A1+A2+An 658.

Among other benefits, this results in none of those participants receiving a so-called “echo” effect wherein their own audio is repeated and reverberates in their own microphone/speaker combination and results in substantial feedback or all chat participants. In addition, this results in less bandwidth usage.

Any chat viewers, such as chat viewer A5 618, receive a master audio stream A1+A2+An 658 incorporating all audio components that are also encoded by the GPU and transmitted, through the chat instance controller 610, to all chat viewers, such as chat viewer A5 618. In this way, the chat viewers receive all audio along with the master video discussed with reference to FIG. 5.

As with the video components above, a CPU in a server can quickly be overwhelmed by the encoding of multiple audio components, for multiple chat participants across multiple, simultaneous chats. The user of a plurality of GPUs to synchronize and encode the audio for each of the on-going chats enables a single current server to handle 10-80 simultaneous chats. Future servers, incorporating better GPUs may increase this number dramatically.

Description of Processes

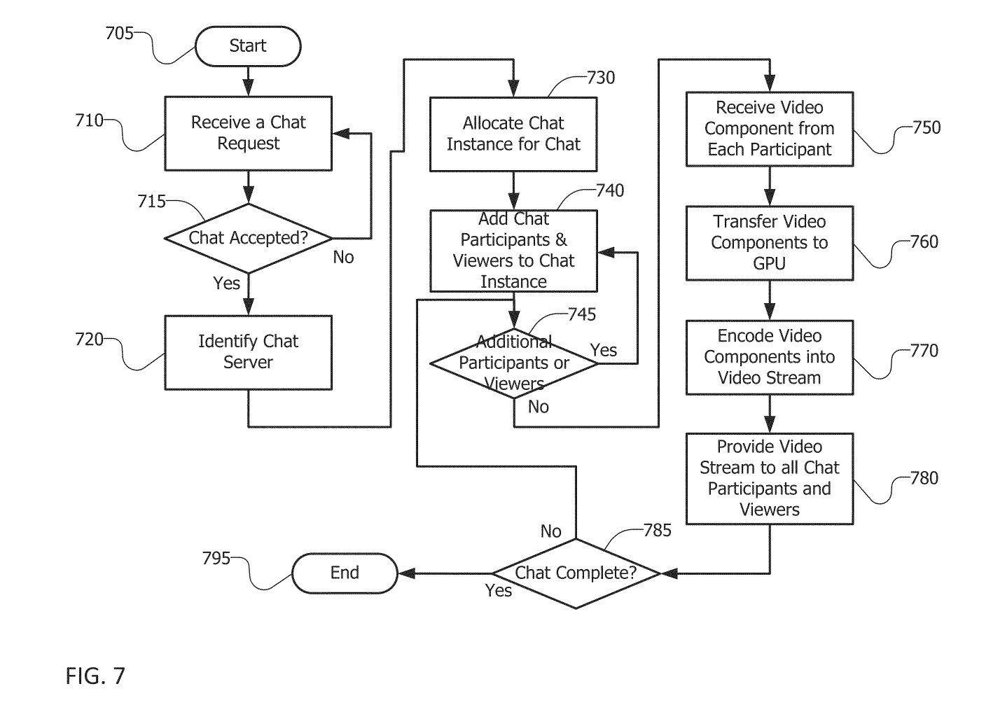

Referring now to FIG. 7, a flowchart of a video encoding process is shown. FIG. 7 has both a start 705 and an end 795, but the process is cyclical in nature, particularly with regard to the encoding-related steps. One or more of the computing devices identified above may be programmed to carry out these steps, using these steps as their algorithm.

The process starts at 705 when a chat request is received at 710. This request may take the form of a user-initiated chat, or a pre-scheduled chat. In either case, a request is forwarded to, for example, the communication system 130 (FIG. 1) for forwarding on to the appropriate recipient identified by the request.

This chat request may take the form of a more traditional chat initiation request asking a potential chat participant that did not initiate the request at 710 to “accept” the incoming chat before the audio and/or video streams begin. Alternatively, and depending upon settings provided by one or both potential chat participants, the audio and/or video components of the initiating, potential chat participant may be provided in place of the more traditional “acceptance” dialogue box. As a result, the recipient potential chat participant may be able to pre-screen the call before his or her audio and/or video components begin streaming to the initiating, potential chat participant.

If the chat is not accepted at 715, a later chat request is awaited at 710. If the chat is accepted at 715, then a chat server is identified at 720. This process, which may be undertaken by the cluster control system 140 (FIG. 1), involves the load balancing functionality of the cluster control system 440 (FIG. 4) to ensure that a given server is capable of handling the requested chat. For example, a test may determine that a CPU load is above a pre-determined threshold (e.g. 80%) and require that the cluster control system 440 allocate a new server on the server cluster 450 in order to host the requested chat.

The cluster control system 440 may allocate a chat instance for the requested chat at 730. This involves creating a unique chat ID, associating a particular chat instance on a server of the server cluster 450 for the chat

At least two chat participants are then added to the chat instance at 740. Once all of the information involved in the allocation is returned to the chat participants, those participants may be added to the chat instance. Subsequent participants may also be added at at 745. For simplification of explanation, this process is shown at this point in the flowchart of FIG. 7, however, additional chat participants may join an on-going chat at any time. In addition, chat participants may leave a chat at any time. In order to simplify the flowchart, a test for additional chat participants, shown at 745, is not shown after each step of FIG. 7

Once at least two chat participants have been added at 745, the process of video encoding begins. Each of the computing devices, such as the mobile device 110 or client system 120, associated with a chat participant begins providing video components, along with a unique user ID and chat ID, to the allocated server at 750. This video is for inclusion in the overall on-going chat.

The server then transfers those video components to one of a plurality of GPUs operating on the server for encoding. The GPU or GPUs encode the individual video components into a master video stream at 770. This involves the synchronization of the video components that are not necessarily received in order or at the same time. Timestamps, internal or otherwise may be used to accomplish this. In addition, this process may, for example, involve encoding of the video into a single master video stream with each of the chat participant's real-time images superimposed over a background or “tiled” across a screen as desired by one or more of the chat participants, dependent upon the number of chat participants, or as set by default depending on the number of chat participants.

The server then returns the master video stream to all chat participants and, to the extent there are any, to all chat viewers at 780. The chat participants and chat viewers, at that point, can see the real-time master video stream.

Next, a determination of whether the chat is complete at 785 is made. If the chat is complete, the process ends at 795. If the chat is not complete (all participants have left the chat), then a determination is made whether there are additional chat participants or viewers at 745 and the process continues. Thus, the processing described from steps 740-780 continues for each frame of video for each of the chat participants until the chat is complete at 785.

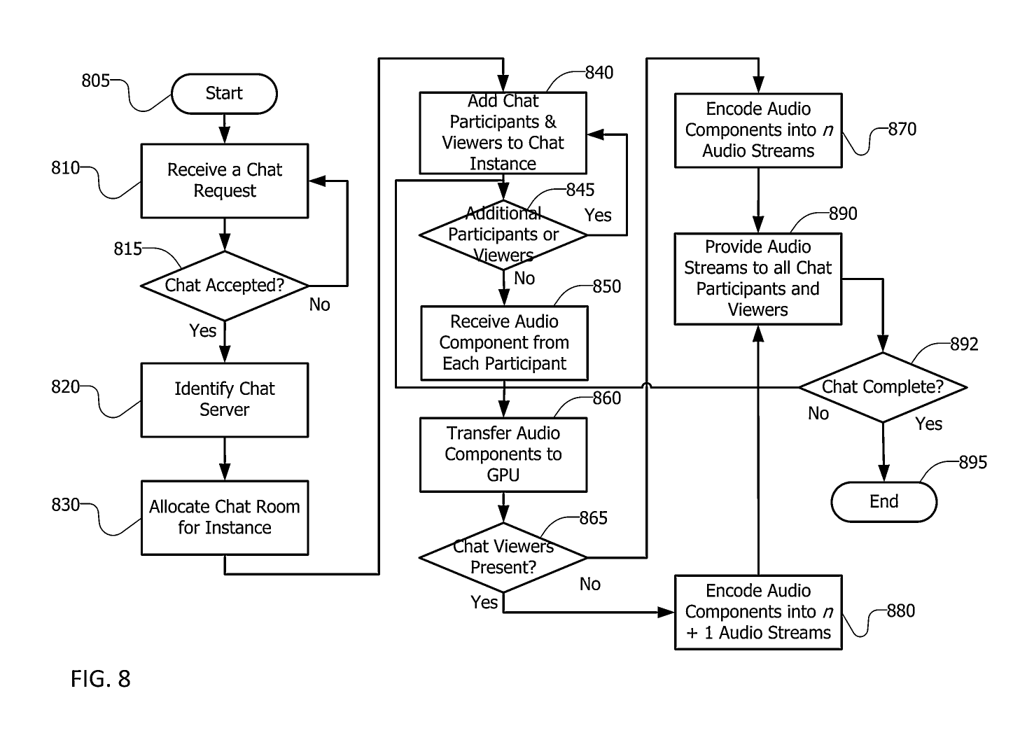

Turning now to FIG. 8, a flowchart of an audio encoding process is shown. FIG. 8 has both a start 805 and an end 895, but the process is cyclical in nature, particularly with regard to the encoding-related steps. One or more of the computing devices identified above may be programmed to carry out these steps, using these steps as their algorithm.

Steps 810-845 mirror steps 710-745 described above. Their description will not be repeated here.

Once at least two participants to the chat have been added, a plurality of audio components are received from each chat participant at 850. These audio components are transferred to one or more GPUs at 860.

A determination is made whether chat viewers are present at 865 or that they are not present. Chats may be viewed by any number of chat viewers in addition to the chat participants. In some cases these numbers may be small, a select team of programmers viewing a meeting among supervisors. In other cases, a small number of chat participants may elect to broadcast their chat to a huge number of viewers, much like a live-streamed television program.

If no chat viewers are present, then the GPU operates to encode the audio components into n combined audio streams, where n is the number of chat participants. Each of the n combined audio streams will include n−1 audio components. At 890, the combined audio stream returned to each of the chat participants will not include that chat participant's audio component.

If any chat viewer is present at 865, then the GPU operates to encode the audio components into n+1 combined audio streams, where n is the number of chat participants. As discussed above, this is one stream, of the n, for each of the chat participants and one master stream (the +1) for all chat viewers. Each of the n combined audio streams includes audio components for n−1 of the chat participants as discussed above. The master audio stream includes all audio components. At step 890, the n combined audio streams are provided to each of the chat participants and the master audio stream is provided to all chat viewers.

If the chat is complete at 892 (meaning that all chat participants have left the chat), then the process ends at 895. If the chat is not complete at 895, then a determination is made whether there are additional chat participants or viewers at 845. Then, the process proceeds as described above with respect to elements 840-892 until a chat is complete at 892, when the process ends.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A real time stream provisioning system comprising:
a cluster controller system for responding to chat requests by dynamically allocating one of a plurality of servers in a server cluster for use in a chat, the chat including an audio component for each of n chat participants, where n is greater than 2;
the server cluster, including a plurality of servers, each of the plurality of servers incorporating at least one graphical processing unit, for
encoding the audio component for each of the n chat participants, using the at least one graphical processing unit, into n audio streams, where the n audio streams each include audio components for n−1 of the n chat participants where each of the n audio streams does not include the audio component for a different one of the n chat participants, and
transmitting one of the n audio streams to the n chat participants such that a chat participant of each of the n chat participants receives an audio stream excluding the audio component associated with the chat participant.

2. The real time stream provisioning system of claim 1, further comprising:
encoding the audio component for each of the plurality of chat participants, using the at least one graphical processing unit, into one master audio stream including the audio components for each of the n chat participants; and
transmitting the master audio stream to a plurality of chat viewers.

3. The real time stream provisioning system of claim 2 wherein the chat further includes a video component for each of the n chat participants and wherein the server cluster is further for:
encoding the video component for each of the plurality of chat participants into a combined video stream using the at least one graphical processing unit; and
transmitting the combined video stream to the chat participants and to the plurality of chat viewers.

4. The real time stream provisioning system of claim 1, wherein each of the chat participants take part in the chat using chat software operating on a mobile device.

5. The real time stream provisioning system of claim 1, wherein each of the plurality of servers in the server cluster relies upon the at least one graphical processing unit in order to perform encoding of the audio component for each of the plurality of chat participants for a plurality of simultaneous chats.

6. The real time stream provisioning system of claim 5 wherein each of the plurality of servers in the server cluster is capable of maintaining more than five simultaneous chats, each involving a distinct plurality of chat participants.

7. The real time stream provisioning system of claim 1 wherein the transmitting relies upon user datagram protocol (UDP).

8. The real time stream provisioning system of claim 1 further comprising a communication system for:
receiving chat requests and communicating the chat requests to the cluster controller system; and
receiving chat initiation messages from the cluster controller system and communicating those messages to the plurality of chat participants and to the chat viewers.

9. A method of provisioning a real time stream, comprising:
responding to chat requests by dynamically allocating one of a plurality of servers in a server cluster for use in a chat, the chat including an audio component for each of n chat participants, where n is greater than 2;
encoding the audio component for each of the n chat participants, using at least one graphical processing unit, into n audio streams, where the n audio streams each include audio components for n−1 of the n chat participants where each of the n audio streams does not include the audio component for a different one of the n chat participants, and
transmitting one of the n audio streams to the n chat participants such that a chat participant of each of the n chat participants receives an audio stream excluding the audio component associated with the chat participant.

10. The method of provisioning a real time stream of claim 9, further comprising:
encoding the audio component for each of the plurality of chat participants, using the at least one graphical processing unit, into one master audio stream including the audio components for each of the n chat participants; and
transmitting the master audio stream to a plurality of chat viewers.

11. The method of provisioning a real time stream of claim 10, wherein chat further includes a video component for each of the n chat participants and further comprising:
encoding the video component for each of the plurality of chat participants into a combined video stream using the at least one graphical processing unit; and
transmitting the combined video stream to the chat participants and to the plurality of chat viewers.

12. The method of provisioning a real time stream of claim 9, wherein each of the chat participants take part in the chat using chat software operating on a mobile device.

13. The method of provisioning a real time stream of claim 9, wherein each of a plurality of servers in a server cluster relies upon the at least one graphical processing unit in order to perform encoding of the audio component for each of the plurality of chat participants for a plurality of simultaneous chats.

14. The method of provisioning a real time stream of claim 13 wherein each of the plurality of servers in the server cluster is capable of maintaining more than five simultaneous chats, each involving a distinct plurality of chat participants.

15. The method of provisioning a real time stream of claim 9 wherein the transmitting relies upon user datagram protocol (UDP).

16. The method of provisioning a real time stream of claim 9 further comprising:
receiving chat requests and communicating the chat requests to a cluster controller system; and
receiving chat initiation messages from the cluster controller system and communicating those messages to the plurality of chat participants and to the chat viewers.
